(19) United States
(12) Patent Application Publication
(10) Pub. No.: US 2022/0040761 A1
(43) Pub. Date: Feb. 10, 2022

(54) LITHIUM-CARBON COMPOSITE MATERIAL AND PREPARATION THEREOF

(71) Applicant: Long Power Systems (Nantong) Co.,Ltd., Nantong (CN)

(72) Inventors: Biying Huang, Nantong (CN); Richard Brian Huang, Nantong (CN); Tianwen Tang, Nantong (CN)

(21) Appl. No.: 17/507,795

(22) Filed: Oct. 21, 2021

(30) Foreign Application Priority Data
Oct. 22, 2020 (CN) 202011135678.2

(51) Int. Cl. B22F 9/06; H01M 4/36; H01M 4/38; H01M 4/62; H01M 6/14

(52) U.S. Cl. CPC B22F 9/06; H01M 4/366; H01M 4/382; B22F 2201/11; H01M 6/14; B22F 2301/054; B22F 2302/40; H01M 4/625

(57) ABSTRACT

A lithium-carbon composite material and a preparation method thereof. The method includes preparation of a micron lithium powder dispersion, adjustment of the solid content of the micron lithium powder dispersion, preparation of a lithium-carbon mixture, and preparation of the lithium-carbon composite material.

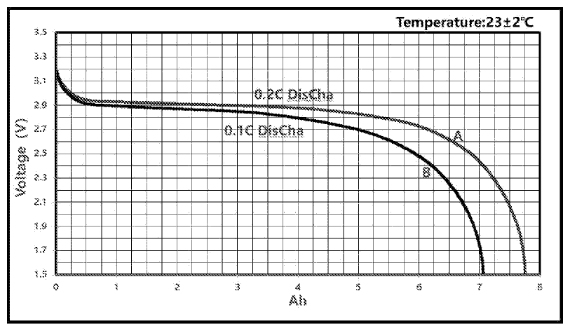

### CROSS-REFERENCE TO RELATED APPLICATIONS

This application claims the benefit of priority from Chinese Patent Application No. 202011135678.2, filed on Oct. 22, 2020. The content of the aforementioned application, including any intervening amendments thereto, is incorporated herein by reference in its entirety.

### TECHNICAL FIELD

The present disclosure relates to lithium-manganese dioxide primary batteries, in particular to a lithium-carbon composite material and a preparation thereof.

### BACKGROUND

The lithium manganese primary battery has been used more and more widely in the market due to its advantages of stable voltage plateau, long storage time, and wide applicable temperature range. Traditionally, the negative electrode of the lithium manganese battery is prepared through the welding of metal lithium strip with a tab. Considering that the metal lithium has extremely high chemical activity, the preparation process raises strict requirements for the temperature and humidity, rendering it difficult to improve the product quality, increasing the processing cost.

In view of the shortcomings of the prior art, this disclosure provides a lithium-carbon composite material and a preparation method thereof to ameliorate the preparation of the anode active material the lithium manganese primary battery.

### SUMMARY

The purpose of the present disclosure is to provide a lithium-carbon composite material and a preparation method thereof to solve the technical problems in the prior art.

Technical problems of the disclosure are described as follows.

In a first aspect, the present disclosure provides a method for preparing a lithium-carbon composite material, comprising:

(S1) dispersing metal lithium in an organic solvent through liquid phase buoyancy to obtain a micron lithium powder dispersion;

(S2) allowing the micron lithium powder dispersion obtained in step (S1) to stand, and removing a part of the organic solvent from the micron lithium powder dispersion such that a lithium powder solid content of the micron lithium powder dispersion is 25%-35%;

(S3) adding carbon powder to the micron lithium powder dispersion obtained through step (S2) followed by cyclical grinding using a sand mill to disperse the carbon powder and lithium powder evenly to obtain a mixed system, where a molar ratio of Li to C is (3-4):1; and

(S4) allowing the organic solvent in the mixed system to evaporate such that the carbon powder in the mixed system is carried by evaporated organic solvent and then settles to cover a surface of the lithium powder to obtain the lithium-carbon composite material.

In an embodiment, the steps (S1)-(S4) are all performed in an argon atmosphere.

In an embodiment, the step (S1) is performed through steps of:

cutting the metal lithium into pieces followed by continuous feeding to a liquid-phase dispersion machine with the organic solvent and stirring, where a weight ratio of the metal lithium to the organic solvent is 3.55:96.45; heating, by a heating device of the liquid-phase dispersion machine, a mixture of the metal lithium and the organic solvent to 180° C.-190° C. under stirring such that the metal lithium melts to form uniformly dispersed micron lithium droplets in the organic solvent; allowing a mixture of the micron lithium droplets and the organic solvent to pass through a built-in 400-800 mesh sieve of the liquid-phase dispersion machine to enter a cooling device of the liquid-phase dispersion machine; and cooling the mixture of the micron lithium droplets and the organic solvent to room temperature such that the micron lithium droplets solidify to form lithium powder with a particle size of 20-40 μm in the organic solvent to obtain the micron lithium powder dispersion.

In an embodiment, in step (S1), the organic solvent is selected from the group consisting of undecane, dodecane, tridecane, tetradecane, pentadecane and a combination.

In an embodiment, the carbon powder is selected from the group consisting of superconducting carbon black, conductive graphite, carbon fiber, carbon nanotube, graphene and a combination.

In an embodiment, the step (S4) is performed through a step of:

drying the mixed system obtained in step (S3) at 100° C.-150° C. and a pressure of −0.08 MPa to −0.1 MPa in a rake vacuum dryer to evaporate the organic solvent to obtain the lithium-carbon composite material.

In a second aspect, the present disclosure also provides a lithium-carbon composite material prepared according to the above method, which is applied to a negative plate of a lithium manganese primary battery.

The beneficial effects of the present disclosure are described as follows.

1. In the lithium-carbon composite material provided herein, the metal lithium powder particles are coated with carbon powder with high electrical conductivity. This type of carbon powder has a stable structure, high specific surface area and high electronic conductivity, and also has good strength, flexibility, and electrical and thermal conductivity, which can not only effectively prevent the lithium powder particles from being exposed to the air, but also can play a role as the conductive agent of the lithium ion battery.

2. In the preparation method of the disclosure, the metal lithium is dispersed in an organic solvent using a liquid-phase dispersion machine. In the liquid-phase dispersion machine, the high-frequency stirring linear speed contributes to the formation of micron-scale lithium droplets from the molten metal lithium; and a 400-800 mesh sieve is provided to filter the micron-scale lithium droplets to ensure that the particle size of the solidified metallic lithium powder is controlled within the range of 20 to 40 μm. The reduction of the mesh size of the sieve facilitates the normal distribution of the particle size of the metallic lithium powder. At the same time, the melting and solidification processes can be carried out continuously, which avoids the intermediate heating and cooling operations, greatly improving the production efficiency and reducing the production cost and energy consumption.

3. Through the grinding process, the agglomeration of carbon powder is effectively prevented, facilitating the disaggregation and uniform dispersion of the carbon powder particles in the alkane solvent.

4. A rake vacuum dryer is employed to promote the evaporation of the organic solvent to facilitate the vapor phase deposition of the carbon powder on the lithium powder, where the alkane solvent is effectively evaporated, separated and recycled. At the same time, the carbon powder particles in the evaporated alkane solvent are deposited on the surface of the metallic lithium powder particles, and effectively adhere to the surface of the metallic lithium powder particles to form an effective protective shell layer at 100-150° C.

5. The lithium-carbon composite material of the disclosure can replace the metal lithium strip to be used as the anode active material of the lithium manganese primary battery, which not only improves the conductivity of the battery, but also effectively improves its electrical performance such as discharge voltage plateau, discharge current rate and energy density. Moreover, it is conducive to maximizing the use of positive/negative electrode materials within the limited space of the battery cell, and is also conducive to reducing the safety risk during the preparation process of the negative plate. At the same time, the raw material cost and the anode processing cost are lowered.

### BRIEF DESCRIPTION OF THE DRAWINGS

This FIGURE schematically illustrates comparison of a lithium manganese primary battery whose anode active material is made of a lithium-carbon composite material of the disclosure and a traditional lithium manganese battery in the discharge performance.

### DETAILED DESCRIPTION OF EMBODIMENTS

In order to promote the understanding of the present disclosure, the disclosure will be described below in detail with reference to the embodiments and accompanying drawings. It should be understood that the embodiments are merely illustrative, and are not intended to limit the scope of the present disclosure.

The present disclosure provides a method for preparing a lithium-carbon composite material, which is described as follows.

(S1) Preparation of micron lithium powder dispersion

The metal lithium is dispersed in an organic solvent through the liquid phase buoyancy to obtain a micron lithium powder dispersion.

(S2) Adjustment of solid content of the lithium dispersion

The micron lithium powder dispersion obtained in step (S1) is allowed to stand, and a part of the organic solvent is removed so that the lithium powder solid content of the dispersion is −25%-35%.

(S3) Preparation of lithium-carbon mixed system

The micron lithium powder dispersion obtained in step (S2) is added with carbon powder and subjected to cyclical grinding with a sand mill to fully disperse the carbon powder and lithium powder to obtain a mixed system, where a molar ratio of Li to C is (3-4):1.

(S4) Preparation of lithium-carbon composite material

The organic solvent in the mixed system is evaporated such that the carbon powder in the mixed system is carried by evaporated organic solvent and then settles to cover a surface of the lithium powder to obtain the lithium-carbon composite material.

In an embodiment, the above steps (S1)-(S4) are all performed in an argon atmosphere.

In an embodiment, the step (S1) is performed through the following steps.

The metal lithium is cut into pieces followed by continuous feeding to a liquid-phase dispersion machine with the organic solvent and stirred, where a weight ratio of the metal lithium to the organic solvent is 3.55:96.45. A mixture of the metal lithium and the organic solvent under stirring is heated to 180° C.-190° C. by a heating device of the liquid-phase dispersion machine, such that the metal lithium melts to form uniformly dispersed micron lithium droplets in the organic solvent. A mixture of the micron lithium droplets and the organic solvent is allowed to pass through a built-in 400-800 mesh sieve of the liquid-phase dispersion machine to enter a cooling device of the liquid-phase dispersion machine. The mixture of the micron lithium droplets and the organic solvent is cooled to room temperature such that the micron lithium droplets solidify to form lithium powder with a particle size of 20-40 μm in the organic solvent to obtain the micron lithium powder dispersion.

In an embodiment, in step (S1), the organic solvent is selected from the group consisting of undecane, dodecane, tridecane, tetradecane, pentadecane and a combination.

In an embodiment, the carbon powder is selected from the group consisting of superconducting carbon black, conductive graphite, carbon fiber, carbon nanotube, graphene and a combination.

In an embodiment, the step (S4) is performed through the following step.

The mixed system obtained in step (S3) at 100° C.-150° C. and a pressure of −0.08 MPa to −0.1 MPa is dried in a rake vacuum dryer to evaporate the organic solvent to obtain the lithium-carbon composite material.

As shown in the FIGURE, the curve A shows the discharge characteristic of a lithium manganese primary battery whose negative plate includes the lithium-carbon composite material prepared by the above method, and the curve B shows the discharge characteristic of a traditional lithium manganese battery which employs a metallic lithium strip as the negative plate. It can be seen from the FIGURE that under the same operation temperature, the discharge voltage plateau and discharge capacity of the lithium manganese battery primary containing the lithium-carbon composite material of the present disclosure at 0.2 C are respectively higher than the discharge voltage plateau and discharge capacity of the traditional lithium manganese primary battery at 0.1 C.

Described above are merely preferred embodiments of the disclosure, which are not intended to limit the disclosure. It should be noted that any changes, modifications and replacements made by those skilled in the art without departing from the spirit of the disclosure should fall within the scope of the disclosure defined by the appended claims.

What is claimed is:

1. A method of preparing a lithium-carbon composite material, comprising:
(S1) dispersing metal lithium in an organic solvent through liquid phase buoyancy to obtain a micron lithium powder dispersion;
(S2) allowing the micron lithium powder dispersion obtained in step (S1) to stand, and removing a part of the organic solvent from the micron lithium powder dispersion such that a lithium powder solid content of the micron lithium powder dispersion is 25%-35%;
(S3) adding carbon powder to the micron lithium powder dispersion obtained through step (S2) followed by cyclical grinding using a sand mill to disperse the carbon powder and lithium powder evenly to obtain a mixed system, wherein a molar ratio of Li to C is (3-4):1; and
(S4) allowing the organic solvent in the mixed system to evaporate such that the carbon powder in the mixed system is carried by evaporated organic solvent and then settles to cover a surface of the lithium powder to obtain the lithium-carbon composite material.

2. The method of claim 1, wherein the steps (S1)-(S4) are all performed in an argon atmosphere.

3. The method of claim 2, wherein the step (S1) is performed through steps of:
cutting the metal lithium into pieces followed by continuous feeding to a liquid-phase dispersion machine with the organic solvent and stirring, wherein a weight ratio of the metal lithium to the organic solvent is 3.55:96.45; heating, by a heating device of the liquid-phase dispersion machine, a mixture of the metal lithium and the organic solvent to 180° C.-190° C. under stirring such that the metal lithium melts to form uniformly dispersed micron lithium droplets in the organic solvent; allowing a mixture of the micron lithium droplets and the organic solvent to pass through a built-in 400-800 mesh sieve of the liquid-phase dispersion machine to enter a cooling device of the liquid-phase dispersion machine; and cooling the mixture of the micron lithium droplets and the organic solvent to room temperature such that the micron lithium droplets solidify to form lithium powder with a particle size of 20-40 μm in the organic solvent to obtain the micron lithium powder dispersion.

4. The method of claim 3, wherein in step (S1), the organic solvent is selected from the group consisting of undecane, dodecane, tridecane, tetradecane, pentadecane and a combination thereof.

5. The method of claim 2, wherein the carbon powder is selected from the group consisting of superconducting carbon black, conductive graphite, carbon fiber, carbon nanotube, graphene and a combination thereof.

6. The method of claim 2, wherein the step (S4) is performed through a step of:
drying the mixed system obtained in step (S3) at 100° C.-150° C. and a pressure of −0.08 MPa to −0.1 MPa in a rake vacuum dryer to evaporate the organic solvent to obtain the lithium-carbon composite material.

7. A lithium-carbon composite material prepared according to the method of claim 1, wherein the lithium-carbon composite material is applied to a negative plate of a lithium-manganese dioxide primary battery.

8. The lithium-carbon composite material of claim 7, wherein the steps (S1)-(S4) are all performed in an argon atmosphere.

9. The lithium-carbon composite material of claim 8, wherein the step (S1) is performed through steps of:
cutting the metal lithium into pieces followed by continuous feeding to a liquid-phase dispersion machine with the organic solvent and stirring, wherein a weight ratio of the metal lithium to the organic solvent is 3.55:96.45; heating, by a heating device of the liquid-phase dispersion machine, a mixture of the metal lithium and the organic solvent to 180° C.-190° C. under stirring such that the metal lithium melts to form uniformly dispersed micron lithium droplets in the organic solvent; allowing a mixture of the micron lithium droplets and the organic solvent to pass through a built-in 400-800 mesh sieve of the liquid-phase dispersion machine to enter a cooling device of the liquid-phase dispersion machine; and cooling the mixture of the micron lithium droplets and the organic solvent to room temperature such that the micron lithium droplets solidify to form lithium powder with a particle size of 20-40 μm in the organic solvent to obtain the micron lithium powder dispersion.

10. The lithium-carbon composite material of claim 10, wherein in step (S1), the organic solvent is selected from the group consisting of undecane, dodecane, tridecane, tetradecane, pentadecane and a combination thereof.

11. The lithium-carbon composite material of claim 8, wherein the carbon powder is selected from the group consisting of superconducting carbon black, conductive graphite, carbon fiber, carbon nanotube, graphene and a combination thereof.

12. The lithium-carbon composite material of claim 8, wherein the step (S4) is performed through a step of:
drying the mixed system obtained in step (S3) at 100° C.-150° C. and a pressure of −0.08 MPa to −0.1 MPa in a rake vacuum dryer to evaporate the organic solvent to obtain the lithium-carbon composite material.
